(19) United States
(12) Patent Application Publication
(10) Pub. No.: US 2007/0005517 A1
(43) Pub. Date: Jan. 4, 2007

(54) Network support for submitting mail handling instructions to a postal service

(75) Inventors: Sandra Lynn True, St. Charles, IL (US); David S. Benco, Winfield, IL (US); Sanjeev Mahajan, Naperville, IL (US); Baoling S. Sheen, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/170,829

(22) Filed: Jun. 30, 2005

(51) Int. Cl. G06F 17/00

(52) U.S. Cl. 705/401

(57) ABSTRACT

A method is provided for supporting a mail control feature in a telecommunications network (30). The method includes: receiving a mail handling instruction from a user, the instruction being received at a facility (20) from an end user terminal (10) operatively connected to the facility (20) and used by the user to enter the instruction, the facility (20) providing the end user terminal (10) access to a telecommunications network (30); identifying a post office (40) that is responsible for delivering mail to the user from which the instruction was received; and, forwarding the received instruction to the identified post office (40).

### FIELD

The present inventive subject matter relates to the telecommunication arts. Particular application is found in conjunction with certain types of telecommunication networks and/or facilities, and the specification makes particular reference thereto. However, it is to be appreciated that aspects of the present inventive subject matter are also amenable to other like applications, networks and/or facilities.

### BACKGROUND

Even with the great strides being made in more advanced communication technologies, to some extent most individuals still communicate (i.e., sent and/or receive correspondence) via so-called ordinary or regular mail that is delivered by a postal service such as the United States Postal Service (USPS). Insomuch as this ordinary mail continues to be utilized, mail recipients at times may want to alter when and/or where their mail is delivered. For example, while an individual is on vacation or otherwise temporarily absent from their residence (i.e., the location where their mail is otherwise routinely delivered), they may desire that the postal service temporarily hold (i.e., not deliver) their mail. In another example, when an individual moves from one location where they are currently receiving their mail to a new location, they may desire to have subsequent mail deliveries (which are otherwise addressed to that individual at the former location) forwarded to their new location.

Mail handling instructions (i.e., hold instructions, forwarding instructions, etc.) have been traditionally provided to the postal service responsible for delivery of the mail using one or more forms designated by the postal service. For example, an individual desiring to change their current mail handling status would go to an appropriate branch or office of the postal service to obtain a form, manually fill-in the obtained form with the requested information, and submit the completed form to the appropriate postal worker. Some individuals, however, may find this too time consuming or burdensome, or they may simply not want to go to the post office in person for whatever reason. Of course, another option would be to have the form delivered to the individual via the postal service, complete the form, and then mail it back it to the appropriate post office. Again, however, some individuals may find this process to slow considering the speed at which ordinary mail is commonly delivered.

Moreover, some approaches for submitting mail handling instructions to a postal service do not readily accommodate certain individuals. For example, an individual may have already embarked on their travels before remembering to have their mail held. Accordingly, at this point, it may be impractical for them to return to their local post office to submit the designated form, or the destination of their travels may be so far away that a mailed form would reach the local post office later than would be desired given the speed at which traditional or ordinary mail is delivered by the postal service.

Individuals generally appreciate the value of convenience and ease when it comes to completing otherwise burdensome or undesirable tasks. Accordingly, it would be advantageous to provide a more convenient and/or easy way to submit mail handling instructions to a postal service.

More recently, in an attempt to provide the public a more convenient and/or easer way to submit mail handling instructions, the USPS has begun accepting mail handling instructions via the Internet. While arguably more convenient and/or easy than the foregoing approaches, this option also has its limitations. For example, presently, the submission of mail hold instructions over the Internet is not available in all zip codes. Moreover, while somewhat ubiquitous, Internet access is not always available to an individual. Accordingly, individuals without access to the Internet and/or those having an address in an unsupported zip code cannot avail themselves of this approach. As such, there remains a desire for at least some individuals to have a more convenient and/or easer way to submit mail handling instructions to a postal service.

Accordingly, a new and improved telecommunications service and/or feature for submitting mail handling instructions to a postal service is disclosed that overcomes the above-referenced problems and others.

### SUMMARY

In accordance with one embodiment, a method is provided for supporting a mail control feature in a telecommunications network. The method includes: receiving a mail handling instruction from a user, the instruction being received at a facility from an end user terminal operatively connected to the facility and used by the user to enter the instruction, the facility providing the end user terminal access to a telecommunications network; identifying a post office that is responsible for delivering mail to the user from which the instruction was received; and, forwarding the received instruction to the identified post office.

In accordance with another embodiment, a system for supporting a mail control feature in a telecommunications network includes: receiving means for receiving a mail handling instruction from a user, the instruction being received at a facility from an end user terminal operatively connected to the facility and used by the user to enter the instruction, the facility providing the end user terminal access to a telecommunications network; identifying means for identifying a post office that is responsible for delivering mail to the user from which the instruction was received; and, forwarding means for forwarding the received instruction to the identified post office.

In accordance with yet another embodiment, a telecommunications facility is provided. The facility is operatively connected to a telecommunications network and provides an end user terminal operatively connected thereto access to the telecommunications network. The facility includes an application server that provides a service to a user, the service operative to: receive a mail handling instruction from the user, the user employing the end user terminal to enter the instruction; identify a post office that is responsible for delivering mail to the user from which the instruction was received; and, forward the received instruction to the identified post office.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary telecommunications network suitable for practicing aspects of the present inventive subject matter.

FIG. 2 is a flow chart showing an exemplary process embodying aspects of the present inventive subject matter.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components that are commonly known in the telecommunications art without further detailed explanation as to their configuration or operation except to the extent they have been modified or altered in accordance with and/or to accommodate the preferred embodiment(s) presented herein.

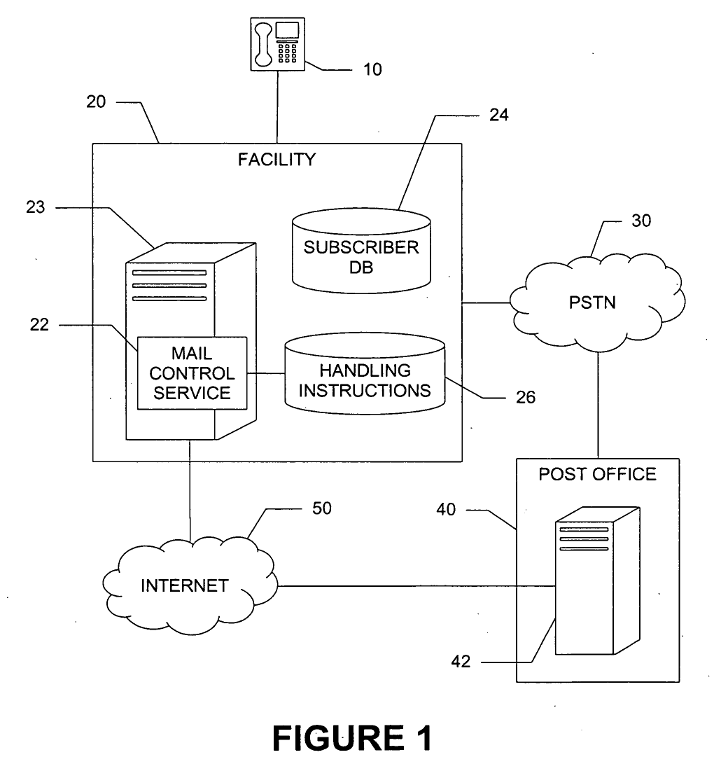

With reference to FIG. 1, an end user terminal (EUT) 10 is selectively employed or used by a user or subscriber to selectively place and/or receive telephone calls over a telecommunications network. Suitably, the terminal 10 is served by a telecommunications facility 20 that is operatively connected to and/or in communication with a public switched telephone network (PSTN) 30 in the usual manner. As shown, the facility 20 is equipped with and/or otherwise has access to a mail control service 22, a subscriber database (DB) 24, and an optional handling instructions DB 26. While for simplicity and clarity herein only one terminal 10 and one facility 20 are illustrated in the present example, it is to be appreciated that a single facility 20 suitably serves a plurality of similarly situated terminals and that a plurality of such facilities are similarly equipped and/or likewise arranged with respect to the PSTN 30. In any event, the switching facility 20 may be provided via any one or more of various suitable implementations.

For example, in a landline or wireline application, the terminal 10 is optionally a landline telephone or other like end user telecommunication device or landline customer premises equipment (CPE), and the facility 20 serving the terminal 10 is an end office (EO) that is operatively connected to the PSTN 30 in the usual manner. Suitably, the EO includes a telecommunications switch (e.g., a class 5 switch such as the 5ESS or another like switch) to which the terminal 10 is operatively connected in the usual manner, e.g., via a twisted-pair landline cable or the like. Alternately, the switching facility 20 takes the form of or is otherwise implemented as a private branch exchange (PBX) (which when used herein shall also refer to a private automatic exchange (PAX) and/or a private automatic branch exchange (PABX) and/or a Centrex® system) or another like switching facility that provides the served EUT 10 with access to the PSTN 30.

In a wireless or mobile application, e.g., the facility 20 serving the terminal 10 is a mobile switching center (MSC) operatively connected to and/or in communication with the PSTN 30 in the usual manner. Suitably, the MSC is also operatively connected to and/or in communication with a plurality of base stations (not shown) in the usual manner. As is understood in the art, each base station (BS) provides an over-the-air radio frequency interface for its respective geographic area or cell. Selectively, the terminal 10 (which in this embodiment is a mobile or wireless telephone or other appropriate mobile station (MS)) is provided telecommunication services and/or otherwise accesses the network via the interface and/or the BS serving the cell in which the MS is located.

The mail control feature or service 22 provides a user a relatively convenient and/or efficient way to submit mail handling instructions (e.g., holding instructions, forwarding instructions, etc.) to a postal service responsible for delivery of the user's regular or ordinary mail. The service 22 functions to receive the mail handling instructions from a user, optionally store the mail handling instructions for a period of time, and forward those instructions to the appropriate branch or office of the postal service which serves the user's address, e.g., such as the illustrated post office 40. In the illustrated embodiment, the mail control feature or service 22 is implemented via a program and/or other appropriate software running on an application server 23, however, it may alternately be implemented in any suitable fashion and/or on another suitable platform or equipment.

Suitably, the service 22 is only made available to a user if they have a proper subscription thereto. Accordingly, subscription information is maintained in the subscriber DB 24 which is queried by the facility 20 to determine the subscription status of an individual attempting to access or use the service 22 prior to permitting actual use of the service 22. For example, the subscriber DB 24 optionally has a list stored therein, and/or otherwise maintains data or information that indicates, which terminals and/or users served by the facility 20 (e.g., identified by their telephone numbers or other like identifiers) do and/or do not subscribe to the feature. Commonly, the subscriber DB 24 also includes an address for each subscriber and/or user served by the facility 20, e.g., for billing purposes or other reasons.

In addition or as an alternative to providing subscription-based access to the service 22, the service 22 is optionally provided on a pay-per-use basis. That is to say, each time a user employs the service 22 they are charged a designated fee.

Suitably, to access the service 22, a user or subscriber places or otherwise initiates a call (e.g., from the EUT 10) to a telephone number that is ascribed to the service 22. Having been connected to the service 22 by the facility 20, the user provides the desired mail handling instructions thereto, e.g., optionally including one or more of the following: a current address (i.e., an address to which the instruction applies); a security code (e.g., a password, a personal identification number (PIN), etc.); a start date (i.e., the date when to start applying the instruction); an end date or duration (i.e., indicating when the instructions expire, after which normal mail delivery is to resume); the type of handling requested (i.e., hold or forward); and/or, a forwarding address when appropriate. For example, the service 22 optionally provides audible or other prompts to enter selected information or data. In response to the prompts, the user optionally supplies the requested information, e.g., using dual-tone multi-frequency (DTMF) input. Alternately, the service 22 is provisioned with or otherwise has access to voice recognition capabilities, and the requested data is entered via verbal responses to the prompts.

In another example, the service 22 is access by the user sending a short message service (SMS) or other suitable text message including the instructions to the service's ascribed telephone number or other designated address. Upon receipt, the service 22 parses the text message to obtain the relevant data items corresponding to the instruction.

In still another example, access to the service 22 is achieved by dialing a prescribed feature code optionally followed by relevant instruction data. Suitably, the type of handling request selected depends on the feature code dialed. That is to say, one feature code is optionally provided for submitting a hold instruction while another is used to submit a forwarding instruction. Optionally, the feature codes are further distinguished to indicate the start of an instruction and the end of an instruction. For example, four feature codes are optionally designated, i.e., one to start the holding of mail, a second to stop the holding of mail, a third the start the forwarding of mail, and a fourth the end the forwarding of mail.

Suitably, the user does not have to provide all the information. For example, some information optionally defaults to certain values (e.g., in some instances certain dates may default to the current date), or as already described, if a feature code is used to provide the instructions to the service 22, the code itself may establish one or more values of the instruction data. Optionally, the current address for the instructions is obtained from the subscriber DB 24. That is to say, using the telephone number of the EUT 10 from which the instructions are received, the service 22 looks up the address associated with the user or subscriber in the DB 24 having that same telephone number. The address obtained from the DB 24 is then used as the current address. Suitably, an automatic number identification (ANI) service, a calling line identity (CLI) feature or the like is employed to obtain the telephone number of the EUT 10 being used to submit the mail handling instructions.

Suitably, the instructions received by the service 22 are processed (i.e., forwarded or otherwise sent to the post office 40) based on their effective date or dates. That is to say, when an instruction is forward by the service 22 to the post office 40 depends upon the effective date of the instruction. In one exemplary embodiment, the instructions received by the service 22 are maintained in the handling instructions DB 26. For each mail handling instruction received by the service 22, a record is created in the DB 26 including fields (e.g., current address, security code, start date, end date or duration, instruction type, forwarding address, etc.) for the various data items associated with the particular instruction. Suitably, the DB 26 is periodically scanned or queried (e.g., daily) by the service 22 to identify those records and/or instructions that are ready to be forwarded or otherwise sent to the post office 40. Optionally, when an instruction received by the service 22 designates both a start date and an end date (or a duration), the service 22 parses the record and/or instruction into separate start and end instructions that are forwarded to the post office 40 independently, e.g., based on their respective effective dates. Alternately, the instructions are forwarded or sent to the post office 40 by the service 22 at or near the time they are received from the user (or periodically in batches at given time intervals) regardless of their effective dates (i.e., the dates in the instructions themselves).

In one exemplary embodiment, the service 22 identifies the post office that is to receive a particular instruction based upon the current address information associated with the instruction, e.g., via a zip code contained in the current address data. Suitably, the service 22 is provisioned with or has access to a look-up-table (LUT) or the like that cross references each post office (e.g., identified by zip code or otherwise) with a designated telephone number, Internet Protocol (IP) address or other like identifier indicating where the service 22 is to send the handling instructions for that particular post office. For example, the service 22 queries the LUT using the zip code obtained from the instructions as an index, thereby to identify and/or select the telephone number, IP address, etc. for the post office serving the address to which the instructions apply. Accordingly, the service 22 forwards or sends each instruction to the appropriate post office serving the current address identified therein.

As shown, the post office 40 is provisioned with an instruction processing server or another appropriate system 42 that is equipped to receive the mail handling instructions from the service 22. Optionally, the system 42 is operatively connected and/or otherwise in communication with the PSTN 30 and/or a data network, e.g., such as the Internet 50. Suitably, the application server 23 is also operatively connected or otherwise in communication with the Internet 50 in the usual manner. Accordingly, the instructions are optionally forwarded or sent to the post office 40 from the service 22 over either the PSTN 30 or the Internet 50 depending on the particular type or types of network connectivity available at either end. For example, the instructions may be forwarded as e-mails or other data messages over the Internet 50, or as SMS messages over the PSTN 40.

Suitably, the post office 40 acknowledges receiving an instruction from the service 22. Optionally, a confirmation is returned in the form of an SMS message, voicemail message, e-mail message, or the like. In one embodiment, the confirmation is returned to the service 22 which in turn provides an appropriate message to the subscriber or user. Alternately, the confirmation is returned directly to the subscriber in the form of an appropriate message from the post office 40. For example, the message suitably indicates what kind of instruction had been received by the post office, its effective date, any expiration or ending date, etc.

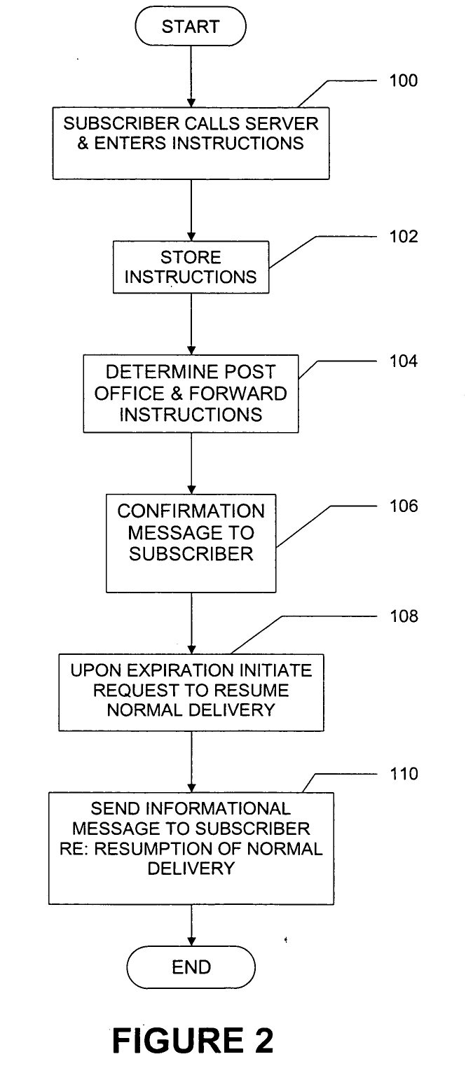

With reference to FIG. 2, an exemplary process illustrating the operation of the mail control service 22 will now be described. The process starts at step 100 with a user initiating a call to the server 23 and entering the instruction details, e.g., name, password, address, start date, end date, hold or forward, etc. At step 102, assuming the user is subscribed to the service 22 and has activated the feature, the subscriber-entered information is stored (e.g., in DB 26). At step 104, it is determined which post office serves the subscriber, and the mail handling instructions are forwarded thereto.

Upon receipt of the mail handling instructions by the post office, at step 106, a confirmation message is returned to the subscriber, e.g., in the form of an SMS message, a voicemail message, an e-mail message, or the like. At step 108, upon expiration of an end date for the instruction, the server 23 initiates a request to the same post office to resume normal mail delivery again. Upon receipt of the resume request, at step 110, an informational message is sent to the subscriber in the form of an SMS message, a voicemail message, an e-mail message or the like, to inform the subscriber that their mail delivery will be resumed, e.g., on the next working day.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for supporting a mail control feature in a telecommunications network, said method comprising:
(a) receiving a mail handling instruction from a user, said instruction being received at a facility from an end user terminal operatively connected to the facility and used by the user to enter the instruction, said facility providing the end user terminal access to a telecommunications network;
(b) identifying a post office that is responsible for delivering mail to the user from which the instruction was received; and,
(c) forwarding the received instruction to the identified post office.

2. The method of claim 1, further comprising:
obtaining an address for the user from a subscriber database.

3. The method of claim 2, wherein the obtained address is employed to identify the post office in step (b).

4. The method of claim 1, wherein the facility is a mobile switching center and the end user device is a mobile station.

5. The method of claim 1, wherein the instruction is a mail hold instruction or a mail forwarding instruction.

6. The method of claim 1, further comprising:
returning a message to the user confirming the forwarding of the instruction to the identified post office.

7. The method of claim 1, further comprising:
prior to step (c) storing the instruction for a period of time, and executing step (c) after the period of time expires.

8. A system for supporting a mail control feature in a telecommunications network, said system comprising:
receiving means for receiving a mail handling instruction from a user, said instruction being received at a facility from an end user terminal operatively connected to the facility and used by the user to enter the instruction, said facility providing the end user terminal access to a telecommunications network;
identifying means for identifying a post office that is responsible for delivering mail to the user from which the instruction was received; and,
forwarding means for forwarding the received instruction to the identified post office.

9. The system of claim 8, further comprising:
obtaining means for obtaining an address for the user from a subscriber database.

10. The system of claim 9, wherein the obtained address is employed by the identifying means to identify the post office.

11. The system of claim 8, wherein the facility is a mobile switching center and the end user device is a mobile station.

12. The system of claim 8, wherein the instruction is a mail hold instruction or a mail forwarding instruction.

13. The system of claim 8, further comprising:
returning means for returning a message to the user confirming the forwarding of the instruction to the identified post office.

14. The system of claim 8, further comprising:
storing means for storing the instruction for a period of time prior to the instruction being forwarded by the forwarding means.

15. A telecommunications facility operatively connected to a telecommunications network, said facility providing an end user terminal operatively connected thereto access to the telecommunications network, said facility comprising:
an application server that provides a service to a user, said service operative to:
receive a mail handling instruction from the user, said user employing the end user terminal to enter the instruction;
identify a post office that is responsible for delivering mail to the user from which the instruction was received; and,
forward the received instruction to the identified post office.

16. The facility of claim 15, further comprising:
a subscriber database from which the service obtains an address for the user.

17. The facility of claim 16, wherein the obtained address is employed to identify the post office.

18. The facility of claim 15, wherein the facility is a mobile switching center and the end user device is a mobile station.

19. The facility of claim 15, wherein the instruction is a mail hold instruction or a mail forwarding instruction.

20. The facility of claim 5, further comprising:
a storage device in which the instruction is stored for a period of time prior to being forwarded by the service.
